(19) United States
(12) Patent Application Publication
(10) Pub. No.: US 2014/0149091 A1
(43) Pub. Date: May 29, 2014

(54) FLUID SIMULATION SYSTEM AND METHOD USING MULTIGRID

(71) Applicants: Kwang Jin Choi, Seoul (KR); Jong Chul Yoon, Seoul (KR)

(72) Inventors: Kwang Jin Choi, Seoul (KR); Jong Chul Yoon, Seoul (KR)

(73) Assignee: FXGEAR INC., Seoul (KR)

(21) Appl. No.: 13/885,153

(22) PCT Filed: Nov. 15, 2010
(86) PCT No.: PCT/KR2010/008058

§ 371 Date: Jul. 16, 2013

(51) Int. Cl. G06F 17/50

(52) U.S. Cl. CPC G06F 17/5009
USPC 703/2

(57) ABSTRACT

A fluid simulation system may include: a state processing unit for defining a corresponding cell after restriction as a Dirichlet cell in the case a Dirichlet cell is present among cells before restriction, defining the corresponding cell after restriction as a Neumann cell in the case a Dirichlet cell is not present and a Neumann cell is present among the cells before restriction, and defining the corresponding cell after restriction as an interior cell in the case a Dirichlet cell and a Neumann cell are not present among the cells before restriction; a restriction operating unit for calculating a residual value of a corresponding interior cell after restriction by adding residual values of interior cells before restriction; and a prolongation operating unit for calculating a residual value of corresponding interior cells after prolongation by dividing a residual value of an interior cell before prolongation by the number of the corresponding interior cells after prolongation.

### TECHNICAL FIELD

Embodiments relate to a system and method for fluid stimulation using a multigrid, and more particularly, to a system and method for fluid stimulation in which state processing of each cell and a conversion operator of a residual value are improved during conversion among grids.

### BACKGROUND ART

In fluid flow simulation, there is known a method of solving a Poisson equation by dividing a boundary of a calculation region into Γ_{D} which is a portion where a Dirichlet boundary condition is applied and Γ_{N} which is a portion where a Neumann boundary condition is applied. Assuming that the calculation region is Ω, the above method may be expressed as Math Figures 1 to 3 below.

Δp=f in Ω⊂R³ [Math Figure 1]

p(x)=α(x) on Γ_{D}, [Math Figure 2]

pn(x)=β(x) on Γ_{N} [Math Figure 3]

FIG. 1 is a schematic view showing a Dirichlet boundary and a Neumann boundary of fluid in a conventional fluid simulation method. In FIG. 1, an upper line depicted in red represents a Dirichlet boundary and side and lower lines depicted in blue represents a Neumann boundary. In addition, an interior region surrounded by these boundaries and depicted in gray represents a calculation region of the fluid. For example, in the case Ω is water which is subject to the fluid flow simulation, the Dirichlet boundary condition may be applied to an interface between the air and water, and the Neumann boundary condition may be applied to an interface between the water and another article put into the water or an interface between the water and a wall of a container.

FIG. 2 is a schematic view showing a state of each cell distinguishably in a general fluid simulation method. In the fluid simulation, each cell of a lattice may be classified into a Dirichlet cell, Neumann cell or an interior cell, based on the above boundaries. In FIG. 2, cells depicted in red and located in an upper portion correspond to Dirichlet cells, spherical cells depicted in blue and located in a middle portion correspond to Neumann cells, and cells depicted in gray and located in a lower portion correspond to interior cells.

A pressure may be defined for the center of each cell classified as described above, and a fluid flow simulation may be calculated by solving the Poisson equation with respect to the defined pressure. For example, assuming that a pressure of a cell located at (i, j, k) is Pᵢⱼₖ, the Poisson equation may be expressed as Math Figures 4 to 6 below.

$$\begin{matrix}{\sum }_{( {i}^{′} , {j}^{′} , {k}^{′} ) ∈ {N}_{ijk}^{*}} \frac{{p}_{{i}^{′} {j}^{′} {k}^{′}} - {p}_{ijk}}{{h}^{2}} = {f}_{ijk} & [ Math Figure 4 ] \\ {ijk}_{} = \{ ( i \pm 1 , j , k ) , ( i , j \pm 1 , k ) , ( i , j , k \pm 1 ) \} & [ Math Figure 5 ] \\ {ijk}_{*}^{} = \{ \begin{matrix}( {i}^{′} , {j}^{′} , {k}^{′} ) ∈ {ijk}_{} \text{:} cell ( {i}^{′} , {j}^{′} , {k}^{′} ) \\ is not Neumann\end{matrix} \} & [ Math Figure 6 ]\end{matrix}$$

In Math Figures 4 to 6, Nijk represents six cells located adjacent to a specific target cell, and N*ijk represents a subset of Nijk except for Neumann cells. In addition, h represents a grid step size.

Meanwhile, FIG. 3 is a diagram showing a multigrid V-cycle algorithm for reducing the operation burden in solving the Poisson equation as described above. As shown in FIG. 3, a method for performing a fluid flow simulation by converting fine grids at an initial stage gradually coarsely (namely, restriction), solving a Poisson equation by using grids restricted to a certain level, and then converting the grids gradually finely (namely, prolongation) again is well known in the art.

The multigrid V-cycle algorithm described above is more specifically disclosed in a paper entitled “A parallel multigrid Poisson solver for fluids simulation on large grids”, jointly authored by A. McAdams, E. Sifakis and J. Teran, which is incorporated herein by reference.

### DISCLOSURE

### Technical Problem

According to an aspect of the invention, it is possible to provide a system and method for fluid simulation, in which state processing of each cell during restriction of grids is improved and a process of converting a residual value of each cell such as restriction and prolongation operators is improved, when fluid simulation is performed by using a multigrid V-cycle algorithm.

### Technical Solution

According to an embodiment, a fluid simulation system may be configured to perform fluid simulation using a multigrid V-cycle algorithm.

The fluid simulation system may include: a state processing unit for defining a corresponding cell after restriction as a Dirichlet cell in the case a Dirichlet cell is present among cells before restriction, defining the corresponding cell after restriction as a Neumann cell in the case a Dirichlet cell is not present and a Neumann cell is present among the cells before restriction, and defining the corresponding cell after restriction as an interior cell in the case a Dirichlet cell and a Neumann cell are not present among the cells before restriction; a restriction operating unit for calculating a residual value of a corresponding interior cell after restriction by adding residual values of interior cells before restriction; and a prolongation operating unit for calculating a residual value of corresponding interior cells after prolongation by dividing a residual value of an interior cell before prolongation by the number of the corresponding interior cells after prolongation.

According to an embodiment, a fluid simulation method may be configured to perform fluid simulation using a multigrid V-cycle algorithm.

The fluid simulation method may include: converting a plurality of cells before restriction into a single cell after restriction; defining the cell after restriction as a Dirichlet cell in the case a Dirichlet cell is present among the plurality of cells before restriction, defining the cell after restriction as a Neumann cell in the case a Dirichlet cell is not present and a Neumann cell is present among the plurality of cells before restriction, and defining the cell after restriction as an interior cell in the case a Dirichlet cell and a Neumann cell are not present among the plurality of cells before restriction; calculating a residual value of a corresponding interior cell after restriction by adding residual values of a plurality of interior cells before restriction; converting a single cell before prolongation into a plurality of cells after prolongation; and calculating a residual value of a plurality of corresponding interior cells after prolongation by dividing a residual value of a single interior cell before prolongation by the number of the plurality of corresponding interior cells after prolongation.

### Advantageous Effects

If the fluid simulation system and method according to an aspect of the invention is used, when fluid simulation is calculated by using a multigrid V-cycle algorithm, state processing of each cell during restriction of grids and a process of converting a residual value of each cell such as restriction and prolongation operators may be improved.

### DESCRIPTION OF DRAWINGS

FIG. 1 is a schematic view showing a fluid boundary in a conventional fluid simulation method.

FIG. 2 is a schematic view showing a state classification of each cell in a conventional fluid simulation method.

FIG. 3 is a schematic view showing a general fluid simulation method using a multigrid V-cycle.

FIG. 4 is a schematic view showing state processing of each cell at restriction in the system and method for fluid simulation according to an embodiment.

FIG. 5 is a schematic view for illustrating a restriction process in the system and method for fluid simulation according to an embodiment.

FIG. 6 is a schematic view for illustrating a prolongation process in the system and method for fluid simulation according to an embodiment.

### BEST MODE

Hereinafter, embodiments of the present disclosure will be described with reference to the accompanying drawings.

A system and method for fluid simulation according to an embodiment may be configured to perform fluid simulation using a multigrid V-cycle algorithm.

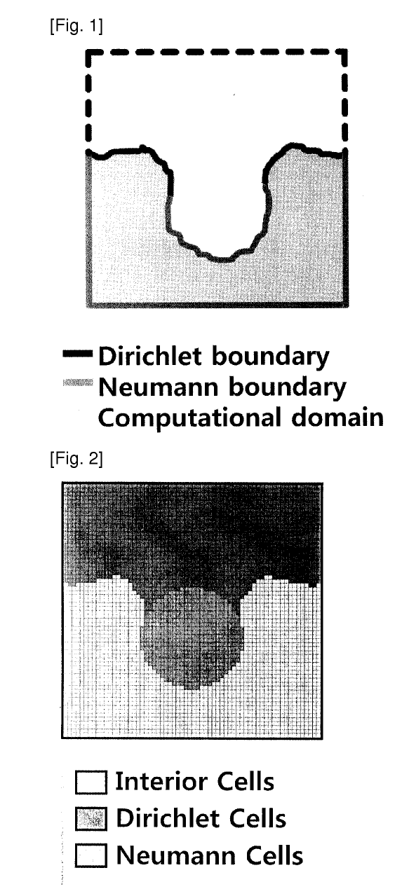

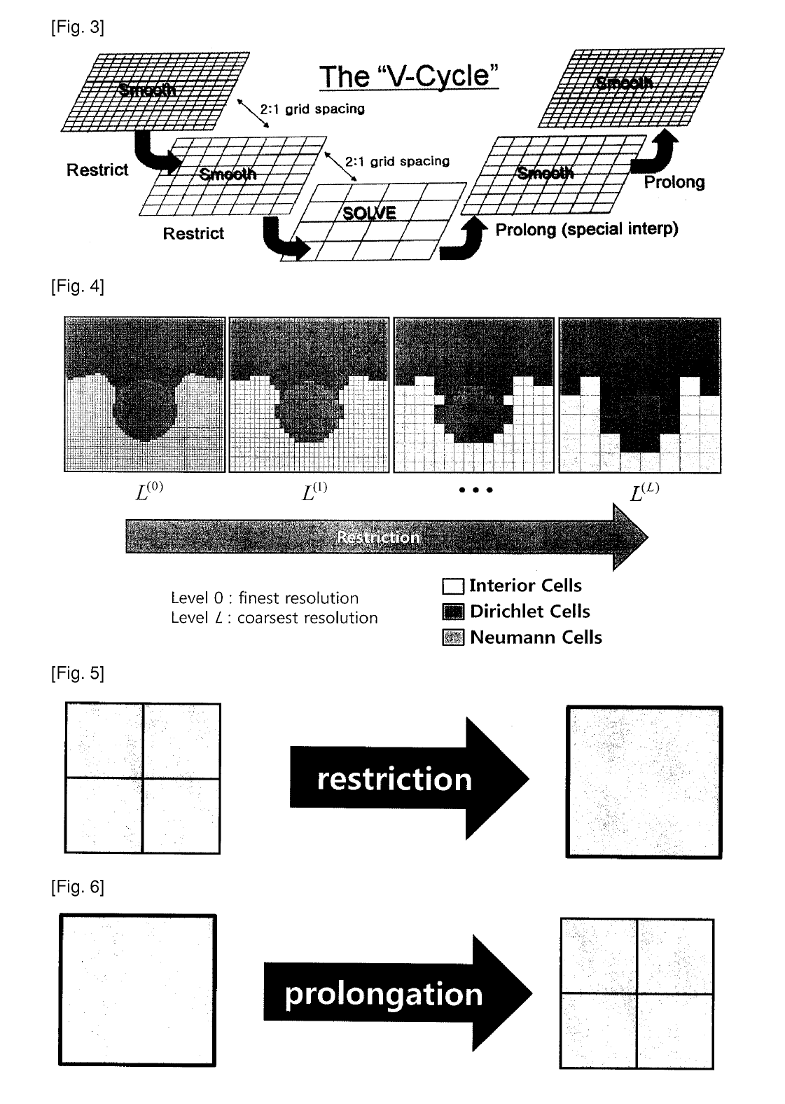

FIG. 4 is a schematic view showing state processing of a cell at restriction in the system and method for fluid simulation according to an embodiment. FIG. 4 depicts a state processing procedure as restriction is performed in a state of each cell described above with reference to FIG. 2.

Referring to FIG. 4, in a multigrid V-cycle algorithm, restriction and/or prolongation may be performed after grids are classified into the (L+1) number of levels. At this time, L(0) represents a grid of a finest resolution, and L(L) represents a grid of a coarsest resolution. As restriction is performed, the grid is gradually converted from L(0) to L(L). At this time, a state of each cell in a grid after restriction (for example, L(n+1)) may be determined based on states of cells located in a corresponding region in a grid before restriction (for example, L(n)).

For this, the fluid simulation system according to an embodiment may include a state processing unit. In the case a Dirichlet is present among cells before restriction, the state processing unit may define the corresponding cell after restriction as a Dirichlet cell. Further, in the case a Dirichlet cell is not present and a Neumann cell is present among the cells before restriction, the state processing unit may define the corresponding cell after restriction as a Neumann cell. Furthermore, in the case a Dirichlet cell and a Neumann cell are not present among the cells before restriction, the state processing unit may define the corresponding cell after restriction as an interior cell.

FIG. 5 is a schematic view for illustrating an operation of a restriction operator in the system and method for fluid simulation according to an embodiment.

Referring to FIG. 5, as restriction is performed, in a grid, a plurality of cells before restriction is converted into a single cell after restriction. At this time, if a state of the restricted cell represents an interior cell, a residual value of the interior cell after restriction may be determined based on a residual value of corresponding interior cells before restriction. As used herein, the term ‘residual’ corresponds to a difference between a final value to be obtained for each cell of a grid and a value obtained up to the current stage.

For this, the fluid simulation system according to an embodiment may include a restriction operating unit for calculating a residual value of the corresponding interior cell after restriction by adding residual values of interior cells before restriction. For example, in case of a two-dimensional lattice, a region of a single cell after restriction corresponds to a region of four cells before restriction. At this time, assuming that a residual value at a position xi on the grid before restriction is f(xi) and a residual value at a position X on a grid after restriction is F(X), F(X) may be calculated as in Math Figure 7 below.

$$F ( X ) = {\sum }_{i = 1}^{4} f ( {x}_{i} ) \qquad [ Math Figure 7 ]$$

In addition, in case of a three-dimensional lattice, since a region of a single cell after restriction corresponds to a region of eight cells before restriction, F(X) may be calculated as in Math Figure 8 below.

$$F ( X ) = {\sum }_{i = 1}^{8} f ( {x}_{i} ) \qquad [ Math Figure 8 ]$$

FIG. 6 is a schematic view for illustrating an operation of a prolongation operator in the system and method for fluid simulation according to an embodiment.

Referring to FIG. 6, as prolongation is performed, a single cell before prolongation in a grid is converted into a plurality of cells after prolongation. At this time, in the case a state of the prolonged cell represents an interior cell, a residual value of the interior cells after prolongation may be determined based on a residual value of the corresponding interior cell before prolongation.

For this, the fluid simulation system according to an embodiment may include a prolongation operating unit for calculating a residual value of the corresponding interior cells after prolongation by dividing a residual value of an interior cell before prolongation by the number of the corresponding interior cells after prolongation. For example, in case of a two-dimensional lattice, a region of a single cell before prolongation corresponds to a region of four cells after prolongation. At this time, assuming that a residual value at a position X on the grid before prolongation is F(X) and a residual value at a position xi on a grid after restriction is f(xi), f(xi) may be calculated as in Math Figure 9 below.

$$f ( {x}_{i} ) = \frac{1}{4} F ( X ) , i = 1 … 4 \qquad [ Math Figure 9 ]$$

In addition, in case of a three-dimensional lattice, since a region of a single cell before prolongation corresponds to a region of eight cells after prolongation, f(xᵢ) may be calculated as in Math Figure 10 below.

$$f ( {x}_{i} ) = \frac{1}{8} F ( X ) , i = 1 … 8 \qquad [ Math Figure 10 ]$$

Though the present disclosure has been described with reference to the embodiments depicted in the drawings, it is just an example, and it should be understood by those skilled in the art that various modifications and equivalents can be made from the disclosure. However, such modifications should be regarded as being within the scope of the present disclosure. Therefore, the true scope of the present disclosure should be defined by the appended claims.

### INDUSTRIAL APPLICABILITY

Embodiments relate to a system and method for fluid stimulation using a multigrid, and more particularly, to a system and method for fluid stimulation in which state processing of each cell and a conversion operator of a residual value are improved during conversion among grids.

1. A fluid simulation system for performing fluid simulation using a multigrid V-cycle algorithm, the system comprising:
a state processing unit for defining a corresponding cell after restriction as a Dirichlet cell in the case a Dirichlet cell is present among cells before restriction, defining the corresponding cell after restriction as a Neumann cell in the case a Dirichlet cell is not present and a Neumann cell is present among the cells before restriction, and defining the corresponding cell after restriction as an interior cell in the case a Dirichlet cell and a Neumann cell are not present among the cells before restriction;
a restriction operating unit for calculating a residual value of a corresponding interior cell after restriction by adding residual values of interior cells before restriction; and
a prolongation operating unit for calculating a residual value of corresponding interior cells after prolongation by dividing a residual value of an interior cell before prolongation by the number of the corresponding interior cells after prolongation.

2. A fluid simulation method for performing fluid simulation using a multigrid V-cycle algorithm, the method comprising:
converting a plurality of cells before restriction into a single cell after restriction;
defining the cell after restriction as a Dirichlet cell in the case a Dirichlet cell is present among the plurality of cells before restriction, defining the cell after restriction as a Neumann cell in the case a Dirichlet cell is not present and a Neumann cell is present among the plurality of cells before restriction, and defining the cell after restriction as an interior cell in the case a Dirichlet cell and a Neumann cell are not present among the plurality of cells before restriction;
calculating a residual value of a corresponding interior cell after restriction by adding residual values of a plurality of interior cells before restriction;
converting a single cell before prolongation into a plurality of cells after prolongation; and
calculating a residual value of a plurality of corresponding interior cells after prolongation by dividing a residual value of a single interior cell before prolongation by the number of the plurality of corresponding interior cells after prolongation.
